(19) United States
(12) Patent Application Publication
(10) Pub. No.: US 2021/0248599 A1
(43) Pub. Date: Aug. 12, 2021

(54) SYSTEM AND METHOD FOR PRIVACY INTERFACE AND OBFUSCATING PAYMENT CARD TRANSACTIONS

(71) Applicant: Mastercard International Incorporated, Purchase, NY (US)

(72) Inventor: Przemek Praszczalek, Irvington, NY (US)

(73) Assignee: Mastercard International Incorporated, Purchase, NY (US)

(21) Appl. No.: 17/169,005

(22) Filed: Feb. 5, 2021

Related U.S. Application Data
(60) Provisional application No. 62/970,971, filed on Feb. 6, 2020.

(51) Int. Cl. G06Q 20/38; G06Q 20/34; G06Q 20/40; G06Q 20/10

(52) U.S. Cl. CPC G06Q 20/383; G06Q 20/108; G06Q 20/405; G06Q 20/357

(57) ABSTRACT

A method and a system are provided for obfuscating payment card holder transactions. The method and system can be configured to capture payment card holder sentiments and moods associated with a privacy or gift mode. A host server provides a control interface comprising an obfuscation server. A payment card processing system processes a payment card transaction from a client device. The client device comprises a payment card user module. The payment card user module comprises an obfuscation client configured to with an obfuscation transaction mode interface. A control interface is configured to allow the payment card user to, via the client device, select or implement an obfuscation criterion for a payment card transaction using a payment card. The obfuscation server is configured to categorize a payment card transaction meeting the obfuscation criterion as an obfuscated payment card transaction

### CROSS-REFERENCE TO RELATED APPLICATION

The present application claims priority to U.S. Provisional Patent Application No. 62/970,971, filed on Feb. 6, 2020, the entirety of which is incorporated by reference herein.

### BACKGROUND OF THE DISCLOSURE

### 1. Field of the Disclosure

The present disclosure relates to a method and a system for a payment card system and payment card system transaction processing.

### 2. Description of the Related Art

In today's ever-connected, digital economy, getting ahead of spending trends and staying relevant with the most valuable customers is an increasingly tricky matter. A new generation of shoppers is re-shaping how U.S. and global businesses reach the customers, build brand affinity, and promote their goods and services.

Financial institutions have offered a variety of new digital services to provide more choice, flexibility, and value-add to the cardholders. Further, as of the present disclosure, over the past few years, personal-consumption expenditures on experience-related services—such as attending spectator events, visiting amusement parks, eating at restaurants, and traveling—have grown more than 1.5 times faster than overall personal-consumption spending and nearly 4.0 times faster than expenditures on goods per se.

Manufacturers, retailers, or other sellers of products (e.g. goods and services) spend a lot of time and money trying to devise ways to get a consumer to buy their products. For example, companies advertise, send incentives for discounts, offer rewards, and other incentives to get consumers to initiate a transaction for the products. However, these efforts are typically provided to the public at large, or at least a relatively large group of consumers, which can result in a high cost and a low return. Also, the timing of any efforts is typically based on when the seller wants to send an incentive, with the seller having no insight as to a beneficial time or manner to send an incentive.

The availability of payment card transaction data provides unique opportunities to service a customer using a payment card. A possible benefit is that if the purchasing sentiment, mood or behavior of a payment card user is known, targeted advertising can be sent to the user of the payment card. Thus, the user is informed of goods or services (products) that are available at a particular merchant, and the issuer receives the possible benefit of one or more additional transactions being conducted by the payment card user.

Further, as explained above, consumers have shown a desire to create “experiences” with purchases, and in particular, gift experiences for friends and loved ones. Examples of such “experience economy” transaction include: surprising a partner with a gift, booking a vacation months in advance of an event (e.g. wedding, anniversary), planning special events (concerts, theatre, date night), personal spending without having to justify the purchase.

However increased transparency and alerts on spending, reporting, and financial tracking makes it difficult to surprise partners or family members with such experiences, as the transaction reporting reveals the surprise. Conventional solutions require obtaining a separate payment card, separate cards, using cash for surprise or discretionary purchases, subterfuges such as having friends or agents make purchases, or simply not going forward with the purchases.

Thus, a need exists for a system and a method that can allow payment card holders to obfuscate or hide payment card transactions for surprises, gift giving, and discretionary spending.

Yet further, a need exists for a system and a method that can analyze purchasing or spending sentiments or moods of payment card users, identify patterns that suggest that a payment card user has a particular set of sentiments, moods, gift motives and privacy motives and use that information for applications such as making offers, preventing fraud, and providing targeted advertisements, creating curated purchase experiences, and the like.

### SUMMARY OF THE DISCLOSURE

Described is a system and a methods therefor that can analyze purchasing or spending sentiments or moods of payment card users, identify patterns that suggest that a payment card user has a particular set of sentiments, moods, gift motives and privacy motives and use that information for applications such as making offers, preventing fraud, and providing targeted advertisements, creating curated purchase experiences, and the like

Described is system and methods therefor comprising: a host server comprising a control interface comprising an obfuscation server; a payment card processing system comprising a processor for processing a payment card transaction; a client device comprising a payment card user module, wherein the payment card user module comprises an obfuscation client configured to include an obfuscation transaction mode interface; a financial server comprising a reporting module configured to obfuscate transactions on a payment card reporting interface; the control interface being configured to allow the payment card user to, via the client device, select a payment card for use with the obfuscation transaction mode interface; and select or implement an obfuscation criterion for a payment card transaction using the selected payment card; and the obfuscation server being configured to categorize a payment card transaction meeting the obfuscation criterion as an obfuscated payment card transaction.

In an embodiment, the system can include an enrollment interface.

In an embodiment, the client device can comprise a banking application including the payment card user module.

In embodiment, the client device can be configured to allow a user to activate an obfuscation mode with obfuscation transaction mode interface. The obfuscated transaction mode interface can be configured to allow a user to set one or more conditions on the transaction. The obfuscated transaction mode interface can be configured to allow the user to set privacy controls on the transaction. The system can be configured to allow the obscured interface to be active for designated period of time.

In an embodiment, the system can be configured to block or prevent permissioned third party systems from accessing obfuscated transactions.

In an embodiment, the system is configured to obfuscate obfuscated transactions on interfaces configured to report or display transactions. The system can be configured to obfuscate obfuscated transactions by one or more of: re-organizing a statement to display obfuscated transactions on a separate page or area; hide transactions in an object requiring activation of the object to display the obfuscated transaction.

In an embodiment, the obfuscation server can comprise a web server configured to serve a commerce profile interface to the client device. The commerce profile interface can be configured to prompt the payment card user via the client device to identify if a payment card transaction is an obfuscated transaction. The commerce profile interface can be served from as a dedicated website or secure remote commerce profile.

In an embodiment, the commerce profile interface can be configured to allow a user to set the obscured transaction criterion as a transaction amount above which the transaction will be obfuscated. The commerce profile interface can be configured to allow a user to set the criterion as an amount for which any transactions under that amount that can be obfuscated. The system can be configured to alert a user when one or more transactions come within a percent or amount of the transaction amount. The amount can be set as an aggregate amount for a plurality of cardholders associated with a single payment card account. The system can be configured to maintain separate limits for each cardholder until the aggregate amount for the single payment card account is met.

### BRIEF DESCRIPTION OF THE DRAWINGS

FIGS. 1A-1B is a diagram of a four party payment card system.

FIG. 2 illustrates a data warehouse that is a central repository of data that is created by storing certain transaction data from transactions occurring in a payment card system.

FIG. 3 is a block diagram of a portion of a payment card system used in accordance with the present disclosure.

FIG. 4 is a diagram of a logical architecture for a system for obfuscating payment card transactions.

FIG. 5 illustrates an overview of a process flow for obfuscating transactions.

FIGS. 6-10 is a block diagram of a process flow for use cases in accord with embodiments.

### DESCRIPTION OF THE EMBODIMENTS

Embodiments of the present disclosure are described more fully hereinafter with reference to the accompanying drawings, in which some, but not all, embodiments of the present disclosure are shown. Indeed, the present disclosure can be embodied in many different forms and should not be construed as limited to the embodiments set forth herein. Rather, these embodiments are provided so that this disclosure clearly satisfies applicable legal requirements.

As used herein, entities can include one or more persons, organizations, businesses, institutions and/or other entities, such as financial institutions, services providers, and the like that implement one or more portions of one or more of the embodiments described and/or contemplated herein. In particular, entities can include a person, business, school, club, fraternity or sorority, an organization having members in a particular trade or profession, sales representative for a particular product, charity, not-for-profit organization, labor union, local government, government agency, or political party.

As used herein, the one or more databases configured to store the first set of information or from which the first set of information is retrieved, and the one or more databases configured to store the second set of information or from which the second set of information is retrieved, can be the same or different databases.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage device, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc” as used herein, include compact disc (CD), laser disc, optical disc, digital versatile disc (DVD), floppy disk and blu-ray disc where disks usually reproduce data magnetically, while discs usually reproduce data optically with lasers. Combinations of the above are included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means that implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process so that the instructions that execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the present disclosure.

Thus, systems, methods and computer programs are herein disclosed to retrieve from one or more databases a first set of information comprising internal information (e.g., payment card transaction information, payment card holder information and merchant information), and optionally retrieve from one or more databases a second set of information comprising external information (e.g., geographic data, firmographic data, demographic data). The first set of information is analyzed to construct one or more groupings of merchants based on merchant line of business or merchant association with a holder sentiment, mood, gift, or privacy motive. The first set of information is also analyzed to identify one or more payment card holder purchase behaviors. One or more payment card holder purchase behaviors are associated (e.g., algorithmically) with one or more groupings of merchants to identify and associate one or more payment card holder sentiments, moods, gifts, or privacy motives with specific merchant categories and with external data.

Among many potential uses, the systems and methods described herein can be used to: (1) allow merchants to better target customers and/or enhance existing customer relationships; and (2) prevent or reduce the risk of fraud associated with payment card transactions. Other uses are possible.

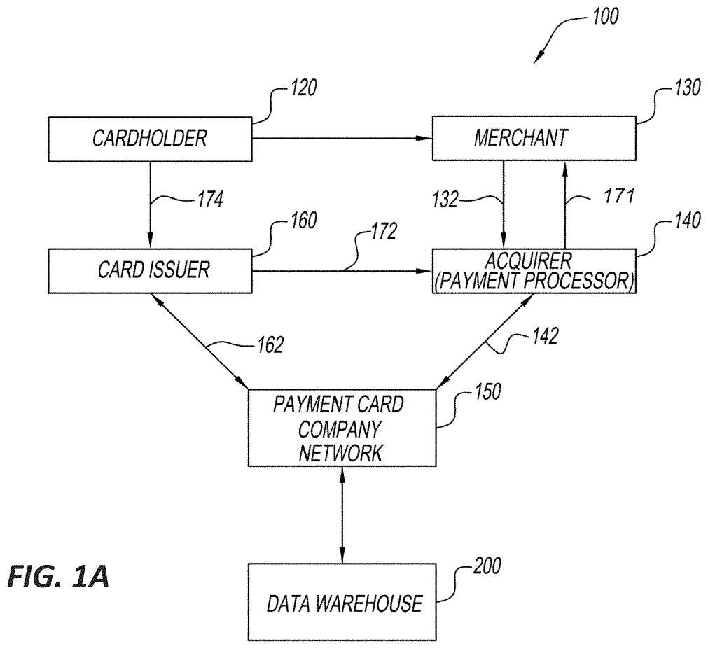

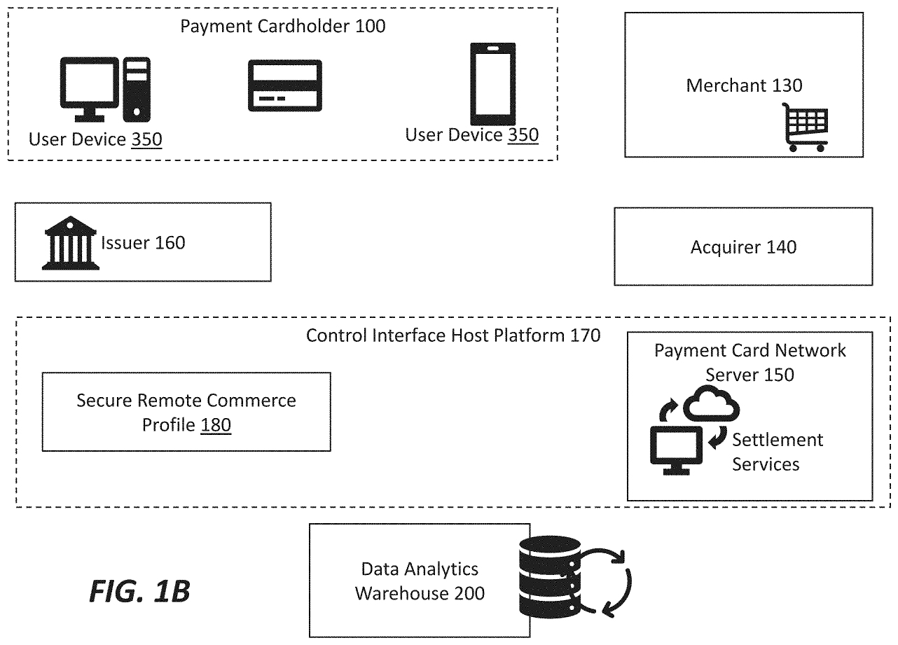

Referring to the drawings and, in particular, FIG. 1, there is shown a four party payment (credit, debit or other) card system architecture generally represented by reference numeral 100. In card system 100, card holder 120 submits the payment card to the merchant 130. The merchant's point of sale (POS) device communicates 132 with their acquiring bank or acquirer 140, which acts as a payment processor. The acquirer 140 initiates, at 142, the transaction on the payment card company network 150. The payment card company network 150 (that includes a financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the merchant 130. Thereafter, seconds later, if the transaction is approved, the card holder completes the purchase and receives a receipt.

The account of the merchant 130 is credited, via 171, by the acquirer 140. The card issuer 160 pays, via 172, the acquirer 140. Eventually, the card holder 120 pays, via 174, the card issuer 160.

Data warehouse 200 is a database used by payment card company network 150 for reporting and data analysis. According to one embodiment, data warehouse 200 is a central repository of data that is created by storing certain transaction data from transactions occurring within four party payment card system 100. According to another embodiment, data warehouse 200 stores, for example, the date, time, amount, location, merchant code, and merchant category for every transaction occurring within payment card network 150. According to another embodiment, data warehouse 200 stores additional data collected from card holder 120, such as mood, sentiment, gift motive, or privacy motive.

In yet another embodiment, data warehouse 200 stores, reviews, and/or analyzes information used in constructing (i) the one or more groupings of merchants based on merchant line of business or merchant association with a holder sentiment, mood, gift, or privacy motive, (ii) the one or more payment card holder purchase behaviors, (iii) the one or more payment card holder sentiment, mood, gift motive, or privacy motive, and (iv) the one or more predictive payment card holder privacy/gift profiles.

In still another embodiment, data warehouse 200 stores, reviews, and/or analyzes information used in creating one or more datasets to store information relating to (i) one or more groupings of merchants based on merchant line of business or merchant association with a holder sentiment, mood, gift, or privacy motive, (ii) one or more payment card holder purchase behaviors, (iii) one or more payment card holder sentiment, mood, gift motive, or privacy motive, and (iv) one or more predictive payment card holder privacy/gift profiles.

In another embodiment, data warehouse 200 stores, reviews, and/or analyzes information used in developing logic for creating (i) the one or more groupings of merchants based on merchant line of business or merchant association with a holder sentiment, mood, gift, or privacy motive, (ii) the one or more payment card holder purchase behaviors, (iii) the one or more payment card holder sentiment, mood, gift, or privacy motive, and (iv) the one or more predictive payment card holder privacy/gift profiles, and applying the logic to a universe of payment card holders to identify one or more payment card holder sentiment, mood, gift, or privacy motive of the universe of payment card holders.

In still another embodiment, data warehouse 200 stores, reviews, and/or analyzes information used in quantifying the strength of the one or more associations of the one or more payment card holder purchase behaviors with the one or more groupings of merchants to identify the strength of the one or more payment card holder sentiment, mood, gift, or privacy motive.

In another embodiment, data warehouse 200 stores, reviews, and/or analyzes information, with respect to the one or more associations between the one or more payment card holder purchase behaviors with the one or more groupings of merchants, used in assigning attributes to the one or more payment card holder purchase behaviors and the one or more groupings of merchants, wherein the attributes are selected from one or more of confidence, time, and frequency.

In yet another embodiment, data warehouse 200 stores, reviews, and/or analyzes information used in identifying one or more payment card holder purchase behaviors, one or more groupings of merchants based on merchant line of business or merchant association with a holder sentiment, mood, gift, or privacy motive, and strength of the one or more associations between the one or more payment card holder purchase behaviors and the one or more groupings of merchants.

In still another embodiment, data warehouse 200 stores, reviews, and/or analyzes information used in determining fraud risk based on the one or more associations between the one or more payment card holder purchase behaviors and the one or more groupings of merchants, or targeting information including at least one or more suggestions or recommendations for payment card holder spending or purchasing activity at a merchant, based on the one or more associations between the one or more payment card holder purchase behaviors and the one or more groupings of merchants.

In another embodiment, data warehouse 200 aggregates the information by payment card holder, merchant, category and/or location. In still another embodiment, data warehouse 200 integrates data from one or more disparate sources. Data warehouse 200 stores current as well as historical data and is used for creating reports, performing analyses on the network, merchant analyses, and performing predictive analyses.

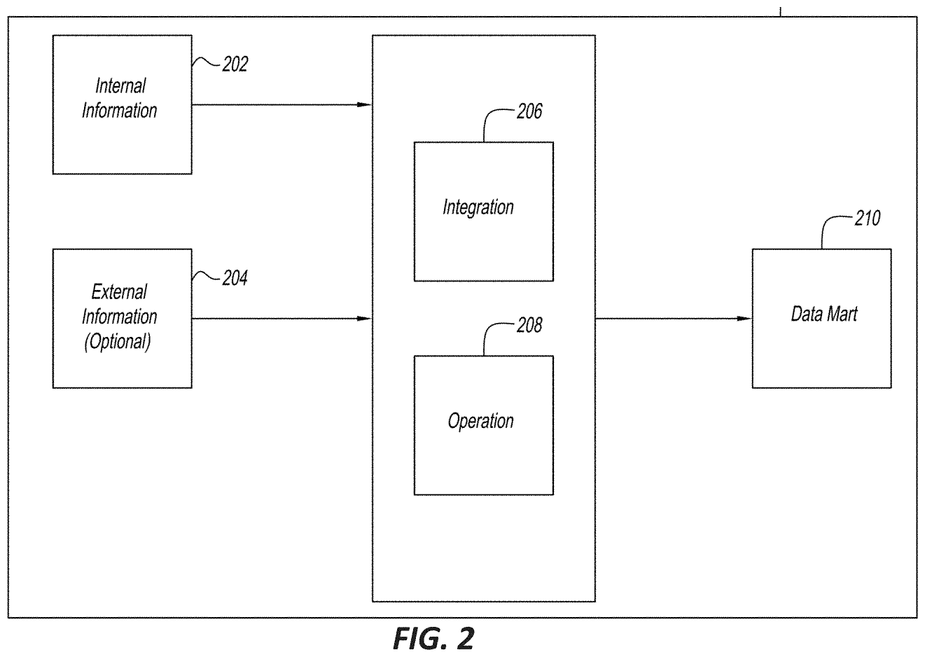

Referring to FIG. 2, an exemplary data warehouse 200 (the same data warehouse 200 in FIG. 1) for reporting and data analysis, including the storing, reviewing, and/or analyzing of information, for the various purposes described above is shown. The data warehouse 200 can have a plurality of entries (e.g., entries 202 and 204).

The internal information (e.g., payment card transaction information) 202 can contain, for example, payment card transaction information, payment card holder information, merchant information, and purchasing and payment activities attributable to purchasers (e.g., payment card holders), that are aggregated by payment card holder, merchant, category and/or location in the data warehouse 200. The internal information 202 includes payment card transactions and actual spending. More specifically, internal information 202 can include, for example, payment card transaction information, payment card holder information, merchant information, transaction date and time, transaction amount, payment card holder information (e.g., payment card holder account identifier (likely anonymized), payment card holder geography (potentially modeled), payment card holder type (consumer/business), payment card holder demographics, and the like), payment card holder sentiment, mood, gift motive, or privacy motive, merchant information (e.g., merchant name, merchant geography, merchant line of business, and the like), payment transaction amount information, and the like.

The external information 204 includes, for example, geographic data, firmographic data, demographic data, lists of individuals with interests and/or hobbies, and other suitable information that can be useful in conducting the systems and methods of this disclosure. The external information 204 can include other suitable information that can be useful in constructing one or more groupings of merchants based on merchant line of business or merchant association with a card holder sentiment, mood, gift motive, or privacy motive, constructing the one or more payment card holder purchase behaviors, and constructing the one or more payment card holder privacy/gift profiles.

The typical data warehouse uses staging, data integration, and access layers to house its key functions. The staging layer or staging database stores raw data extracted from each of the disparate source data systems. The integration layer integrates at 206 the disparate data sets by transforming the data from the staging layer often storing this transformed data in an operational data store database 208. For example, the payment card transaction information 202 can be aggregated by merchant, category and/or location at 206. Also, the reporting and data analysis, including the storing, reviewing, and/or analyzing of information, for the various purposes described above, can occur in data warehouse 200. The integrated data is then moved to yet another database, often called the data warehouse database or data mart 210, where the data is arranged into hierarchical groups often called dimensions and into facts and aggregate facts. The access layer helps users retrieve data.

A data warehouse constructed from integrated data source systems does not require staging databases or operational data store databases. The integrated data source systems can be considered to be a part of a distributed operational data store layer. Data federation methods or data virtualization methods can be used to access the distributed integrated source data systems to consolidate and aggregate data directly into the data warehouse database tables. Integrated source data systems and the data warehouse are all integrated since there is no transformation of dimensional or reference data. This integrated data warehouse architecture supports the drill down from the aggregate data of the data warehouse to the transactional data of the integrated source data systems.

The data mart 210 is a small data warehouse focused on a specific area of interest. For example, the data mart 210 can be focused on one or more of reporting and data analysis, including the storing, reviewing, and/or analyzing of information, for any of the various purposes described above. Data warehouses can be subdivided into data marts for improved performance and ease of use within that area. Alternatively, an organization can create one or more data marts as first steps towards a larger and more complex enterprise data warehouse.

This definition of the data warehouse focuses on data storage. The main source of the data is cleaned, transformed, cataloged and made available for use by managers and other business professionals for data mining, online analytical processing, market research and decision support. However, the means to retrieve and analyze data, to extract, transform and load data, and to manage the data dictionary are also considered essential components of a data warehousing system. Many references to data warehousing use this broader context. Thus, an expanded definition for data warehousing includes business intelligence tools, tools to extract, transform and load data into the repository, and tools to manage and retrieve metadata.

Algorithms can be employed to determine formulaic descriptions of the integration of the data source information using any of a variety of known mathematical techniques. These formulas in turn can be used to derive or generate one or more analyses and updates for analyzing, creating, comparing and identifying activities using any of a variety of available trend analysis algorithms. For example, these formulas can be used in the reporting and data analysis, including the storing, reviewing, and/or analyzing of information, for the various purposes described above.

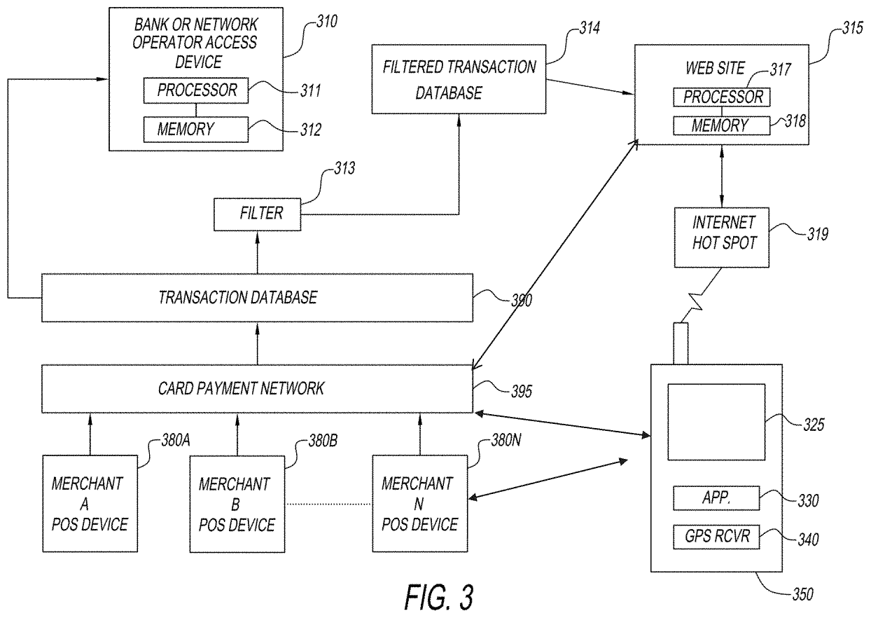

Referring to FIG. 3, a portion of a payment card system used in accordance with the present disclosure is shown. Each merchant that accepts a payment card has on their premises at least one card swiping machine or point of sale device 380, of a type well known in the art, for initiating customer transactions. These point of sale devices 380A, 380B, . . . 380N, generally have a keyboard data pad for entering data when a card's magnetic coding becomes difficult to read, or for the purpose of entering card data resulting from telephone calls during which the customer provides card data by telephone.

A point of sale device can also be configured to support payment card transactions executed via digital wallets, for example, Apple Pay™ or Google Wallet™. A point of sale device can also include electronic commerce transactions over a merchant website or payment card network commerce website 320 configured to process payment card transactions for payment card holder transacting over the internet on a user device 350.

Point of sale devices 380A, 380B, . . . 380N are connected by a suitable card payment network 395 (the payment card company network 150 in FIG. 1) to a transaction database 390 associated with or within network 395 that stores information concerning the transactions. The transaction database is included in the data warehouse 200 in FIGS. 1 and 2. An example of such a network 395 is BankNet operated by MasterCard International Incorporated. BankNet is a four party payment network that connects a card issuer, a card holder, merchants, and an acquiring bank, as is well known in the art. In another embodiment, network 395 can be a three party system. In any such embodiment, POS devices 380 do not have direct access to transaction database 390. It is the operator of network 395 that can access transaction database 390.

Information in database 390 can be accessed by a bank or network operator access device 310, such as a computer having a processor 311 and a memory 312. Users of device 310 can be employees of the bank or a payment network operator who are doing research or development work, such as running inquiries, to carry out the reporting and data analysis, including the storing, reviewing, and/or analyzing of information, for the various purposes described above.

Transaction records stored in transaction database 390 contain information that is highly confidential and must be maintained confidential to prevent fraud and identity theft. The transaction records stored in transaction database 390 can be anonymized by using a filter 313 that removes confidential information, but retains records concerning all of the other transaction related details discussed above, preferably in real time. Anonymized data is generally necessary for marketing applications. The filtered data is stored in a filtered transaction database 314 that can be accessed as described below. The data in the filtered transaction database 314 can be stored in any type of memory including a hard drive, a flash memory, on a CD, in a RAM, or any other suitable memory.

A user device 350 having a display 325 can have a series of applications or applets thereon including an applet or application program (hereinafter an application or app) 330 for use with the embodiment described herein. Applications 330 can include computer executable instructions, which can be loaded into mass memory and run on operating system 306. Examples of application programs can include transcoders, schedulers, calendars, database programs, word processing programs, Hypertext Transfer Protocol (HTTP) programs, customizable user interface programs, IPSec applications, encryption programs, security programs, SMS message servers, IM message servers, email servers, account managers, and so forth. Applications 330 can also include, Banking Application 334, Obfuscation Client, 332 Financial Tool 333, Virtual Assistant Client 331, and Web Browser 335.

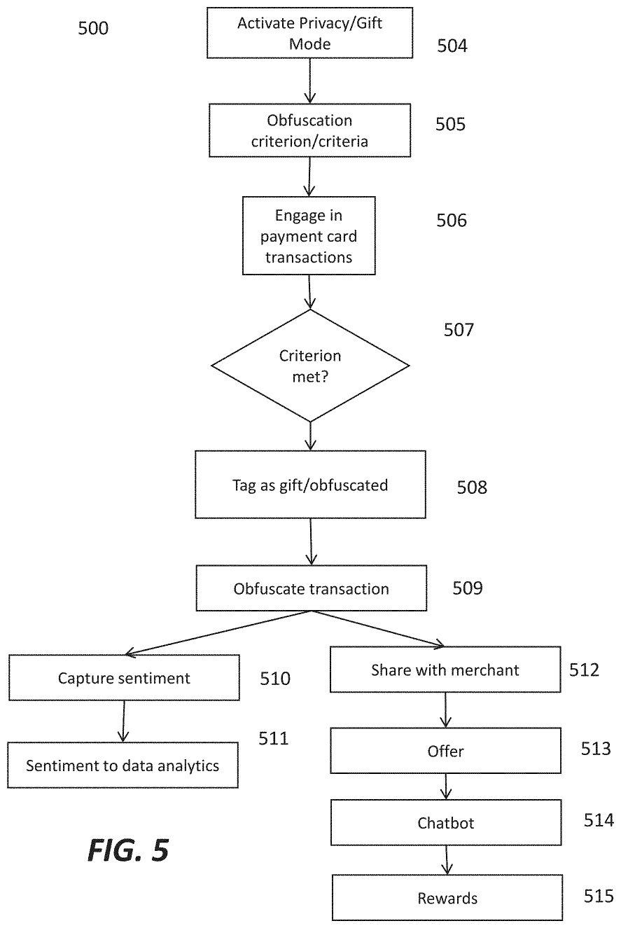

Applications 330 can be configured to can be hosted on control interface host 170 server computers. In at least one of the various embodiments, applications 330 or components of applications 330 can also be operative on merchant 130 server computer 130, issuing bank 160 server computer, or payment card 150 server computer. In any event, applications 330 can employ processes, or parts of processes, similar to those described in conjunction with FIGS. 5-10, to perform at least some of its actions.

User device 350 can also be equipped with a GPS receiver 340 so that its position is always known.

Web page server 315 comprises a processor 317 configured to serve a web page for providing a web page to allow a user to access and activate an SRC profile 180. The web page server 315 can also be configured to serve a dedicated commerce portal hosted by, for example, a payment card company, for merchant transactions for merchants registered with and who provide goods and services via the payment card company commerce portal. A memory 318 associated with web page server 315 having a non-transitory computer readable medium, stores computer readable instructions for use by processor 317 in implementing the operation of the disclosed embodiment. Webpage server processor 317 can also be configured to assemble data from filtered transaction database 314 for responding to inquiries.

Web page server 315 can represent any of a variety of information and services that are configured to provide content, including messages, over a network to another computer. Thus, web page server 315 can include, for example, a web server, a File Transfer Protocol (FTP) server, a database server, a content server, or the like. Web page server 315 can provide the content including messages over the network using any of a variety of formats including, but not limited to WAP, HDML, WML, SGML, HTML, XML, Compact HTML (cHTML), Extensible HTML (xHTML), or the like.

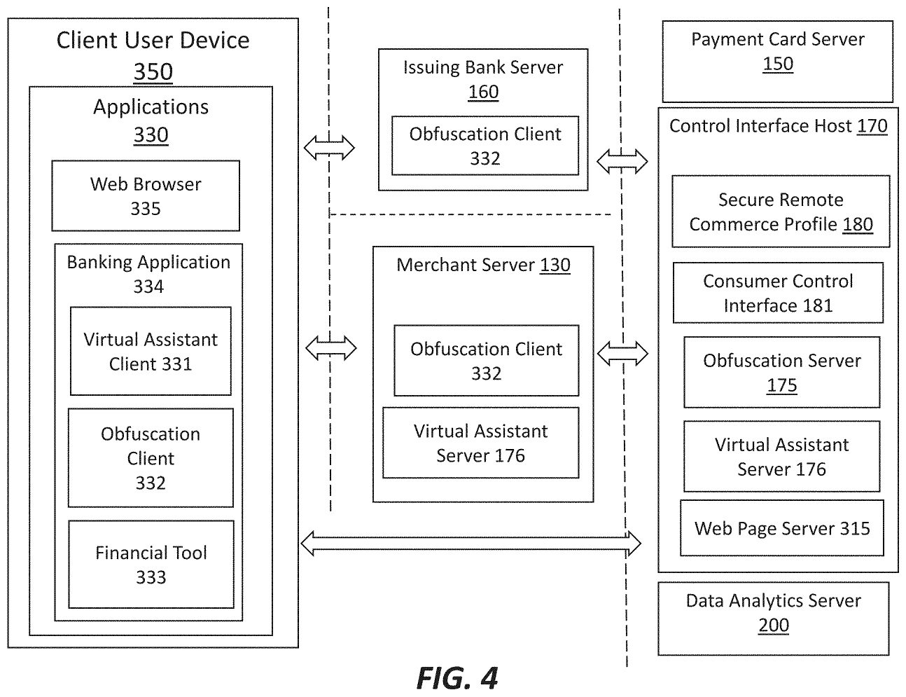

As shown in FIG. 4, in an embodiment, user device 350 includes a banking application 334 configured with a privacy or gift mode interface (“privacy mode” and “gift mode” are used interchangeably herein) configured to obfuscate payment card transactions. The banking application 334 privacy mode is configured to allow a user to set or implement obfuscation criteria for payment card transactions. For example, the banking application 334 can be configured to allow a user to obscure transactions such that they are hidden and obscured on application and display interfaces, reports, notifications and financial management services. The application can include various privacy modes to manage transaction privacy, such as a gift mode for identifying and setting limits on transactions for obfuscation as well as setting conditions on purchases and transactions made in the gift mode. The banking application 334 can include a financial tool 333 for other functions related to transactions, such as alerts, budgeting, and notifications on privacy mode transaction limits, applying for credit, or setting up installment payment or delays on the transaction.

The banking application 334 can also be configured to allow a user to enroll and create a privacy or gift mode profile.

User device 350 banking application 334 also has an obfuscation client 332 configured to interface with an obfuscation server 175 at a control interface host 175. The obfuscation client is configured to hide transactions reported in the banking application 334 that are transacted in a privacy mode.

User device 350 can be used to access a website 320 served by a web page server 315 on the Internet, via a hardwired or Internet connected Wi-Fi hot spot 319 (or by any telephone network, such as a 3G, 4G or 5G system, on which user device 350 communicates), by using application 334. A website 320 can also be linked to filtered transaction database 314 so that authorized users of website 320 can have access to the data contained therein.

FIG. 4 illustrates a logical architecture of system 400 for transaction obfuscation and analytics in accordance with at least one of the various embodiments. In at least one of the various embodiments, control interface host 170 can be arranged to be in communication with payment card server 150, issuing bank server 160, merchant server, data analytics servers 200 or the like.

In at least one embodiment, control interface host 170 can be one or more computers arranged to comprise to include and manage a plurality of Secure Remote Commerce (SRC) profiles for payment card holders, consumer control interfaces 181, obfuscation servers 175, virtual assistant servers 176, and web page servers 315. The control interface host 170 can be configured to manage clients and client applications such as those on issuing bank server, 160, merchant server 130, and data analytics server 200, or the like. For example, control interface host 170 can include one or more web servers 315 providing web sites, including an online commercial portal, or the like. In at least one embodiment, control interface host 170 can be arranged to integrate with payment card server 150, issuing bank server 160, merchant server, and data analytics server 200.

In at least one embodiment, control interface host 170, can include one or more third-party and/or external content provider services. Control interface host 170 can include, integration with, for example, social network platforms, media distribution platforms, or the like. In at least embodiment, control interface host 170 can be arranged to integrate and/or communicate with payment card server 150, issuing bank server 160, merchant server, data analytics server 200, and client user devices 350 using API's or other communication interfaces provided by the services. For example, one content provider service can offer a HTTP/REST based interface that enables obscured transactions and privacy or gift modes as described herein.

Accordingly, FIG. 4 shows an embodiment of a payment card network 395 system including a control interface host 170 configured to allow users to obfuscate transactions. As shown in embodiments, the control interface host 170 can be hosted by the payment card network 395. However in other embodiments, modules for the control interface can be hosted or executed by other entities of the payment card network, for example, the issuing bank 160, or by merchants on by a merchant server 130.

As shown in FIG. 4, the control interface host 170 comprises a SRC profile 180 interface module configured to allow client user devices 350 of payment card holders set user SRC profiles for privacy mode transactions.

The control interface host 170 comprises a consumer control interface 181 configured to interface with a client user device 350 to serve a banking application 334 or a web portal for an SRC profile, including features for a privacy mode. The consumer control interfaces can be configured to allow a user to control accounts and payments for accounts linked to the payment card (e.g. merchant accounts), personalized alerts (real-time), set criteria for a privacy mode (Amount, Budget, Channel, Merchant, Travel, Cross-border, MCC, and/or Combination), control notifications (e.g.: SMS, Push, E-mail, FB Messenger), credit (e.g.: available for debit, credit, prepaid), tools to drive usage and “top-of-wallet” payment cards, and integration into card issuer existing assets.

The control interface host 170 comprises an obfuscation server 175 configured to tag transactions that meet obfuscation criteria for transactions made in a privacy mode. The obfuscation server is configured to interface with obfuscations clients 332 in the user device 350, a merchant server 130, and an issuing bank server 160 to obfuscate reporting and notifications of privacy mode transactions. For example, and obfuscation server 175 on the payment card network 395 can be configured to interface with an obfuscation client 332 at a web-based reporting portal for that bank. The obfuscation server can be configured to instruct or control the obfuscation client at the issuing bank to conceal transactions tagged as obfuscated on a display interface behind a link or interface object that must be activated by a user to display the transaction. The obfuscation server can also instruct the obfuscation client to place any transactions tagged as obfuscated at the end of a statement on a separate page or interface for the statement.

As shown in FIG. 4, a virtual assistant can be implemented according to a client-server model. The virtual assistant can include a client-side portion 331 executed on a user device 350 such as a smart phone or handheld computer, and a server-side portion executed on a server system, for example on control interface host server 170 or merchant server 130. The client device 350 can communicate with a server system through one or more networks 319, which can include the Internet, an intranet, or any other wired or wireless public or private network.

The client-side portion executed on the user device 350 can provide client-side functionalities, such as user-facing input and output processing and communications with server system. Server system can provide server-side functionalities for any number of clients residing on a respective user device.

Server systems can include one or more virtual assistant servers 176 that can include a client-facing I/O interface, one or more processing modules, data and model storage, and an I/O interface to external services. The client-facing I/O interface can facilitate the client-facing input and output processing for virtual assistant server 176. The one or more processing modules can utilize data and model storage to determine the user's intent based on natural language input, and can perform task execution based on inferred user intent. Virtual assistant server can include an external services I/O interface configured to communicate with external services, such as telephony services, calendar services, information services, messaging services, navigation services, and the like, through network(s) for task completion or information acquisition. The I/O interface to external services can facilitate such communications.

Server systems can be implemented on one or more standalone data processing computers.

Although the functionality of the virtual assistant is described in as including both a client-side portion 331 and a server-side portion 176, in some examples, the functions of an assistant (or speech recognition in general) can be implemented as a standalone application installed on user device 350. In addition, the division of functionalities between the client and server portions of the virtual assistant can vary in different examples.

One of ordinary skill in the art will appreciate that the architecture of systems as described herein are a non-limiting example that is illustrative of at least a portion of at least one of the various embodiments. As such, more or less components can be employed and/or arranged differently without departing from the scope of the innovations described herein. However, descriptions are sufficient for disclosing at least the innovations claimed herein.

The operation of certain aspects will now be described with respect to FIGS. 5-10. In at least one of various embodiments, processes 500, 600, 700, 800, 900, and 100 described in conjunction with FIGS. 5-10, respectively, may be implemented by and/or executed on a one or more network computers. In other embodiments, these processes or portions of these processes may be implemented by and/or executed on a plurality of network computers, such as network computer. Likewise, in at least one of the various embodiments, processes 500, 600, 700, 800, 900, 1000 or portions thereof, may be operative on one or more client computers, such as client computer. However, embodiments are not so limited, and various combinations of network computers, client computers, virtual machines, or the like may be utilized. Further, in at least one of the various embodiments, the processes described in conjunction with FIGS. 5-10 can be operative in system with logical architectures such as those described in conjunction with FIGS. 1-4.

FIGS. 5-10 are flowcharts for system processes 600, 700, 800, 900, 1000 for a privacy mode or gift mode use cases for obscuring transactions in accordance various embodiments. The system and flows provide a number of advantages, including a banking application or SRC profile configured to provide a user device with a privacy mode or gift mode interface. The Banking application or SRC profile interface can be configured to provide features such as determining whether a merchant falls into the “Gift Mode” category (e.g. if a “Gift Mode” is automatically enabled or defaulted for all jewelry purchases via Card/PAN # sign-up). The Banking application can be configured to allow a user to look up whether merchants offer any discounts for people seeking gifts/surprises.

Another advantage is transactions can be obfuscated online as a “surprise” purchase, which can be revealed in interfaces, for example, after double-clicking on the individual item, and bypassing a spoiler alert from the application or on a reporting interface. The system can also be configured to not allow third party financial software or software as a service platforms (e.g. Mint, etc.) to pull “Gift Mode” transactions.

The system can be configured to allow a user to place conditions on an obfuscated transaction, for example, a long-term, 180-day hold on the posting of the purchase, or a longer return policy. The user can also set the conditions for the surprise purchase, for example, delivery and notification options.

The system is also configured to generate and categorize new data that acts as a proxy for discretionary spending in a privacy or gift mode (e.g. purchase sequence aspect, date/time of “gift spend”, indication of future plans/travel patterns). Powerful analytics are enabled by access to millions transactions labeled as “gift” or “private” purchases.

FIG. 5 illustrates an overview flowchart for process 500 for a privacy mode or gift mode use case and system flow for obscuring transactions in accordance with at least one of the various embodiments. At block 504, in at least one of the various embodiments, a user engaging in a payment transaction at a merchant activates a privacy mode via a privacy mode interface. The privacy mode interface can be accessed via a number of portals, for example via a bank application 334, a payment card host website 320, or an SRC profile offered by a control interface host.

At block 505, the system is configured to select or implement an obfuscation criterion or criteria for payment card transactions to be obfuscated using the privacy mode. Examples of obfuscation criteria include a time criterion (e.g.: all transactions for a given time period are obfuscated) or a category criterion (e.g.: type of merchant, good or service, SIC code). The system can also be configured to allow a user to select specific transactions for obfuscation.

Once the privacy mode is activated and the obfuscation criterion set, at block 506 the user engages in the transaction at a POS device at a merchant or online.

At block 507, the system is configured to determine if the obfuscation criterion is met or the transaction has been selected for obfuscation. If so at block 508, the control interface host 170 tags the transaction for that account as an obfuscated transaction. The control interface host then informs the payment card network and/or the card issuer 160 that transactions meeting the obfuscation criterion for the payment card account are to be obfuscated. At block 509, the system processes the transaction so that issuer 160, payment card system, or other entities that record and report the transaction will obfuscate the transaction on interfaces, statements and reports as described herein.

In an embodiment, the system can be configured to capture a payment card holder user's sentiment when using the privacy interface to obfuscate transactions. At block 510, the privacy mode interface can be configured to have the user to select or enter a purchaser sentiment, mood, gift motive or privacy motive for the transaction. For example, the interface can be configured with a “gift mood” that prompts the payment card user to enter a reason or mood for a transaction made in gift mode. In an embodiment, the interface can be configured to present a list of moods or sentiments, for example, “love”, “friendship”, “caring”, “sympathy”, “compassion”, “surprise”, “excited”, “comfort”, “personal”, and so on. In an embodiment, the system can be configured to allow the user to enter their own description of their sentiment in a text entry field. In another embodiment, the sentiment can be linked to the type of obfuscation criterion. For example, a transaction for discretionary spending under a privacy mode spending limit for a family account can be automatically tagged as “discretionary” or “personal”.

At block 511, the system can be configured to send the sentiment data to a data analytics server of a data warehouse 200. The data analytics server can then add this sentiment data for analysis and payment card user profiles and improved targeting as described herein. As will be appreciated, such data adds a unique data feature for analysis beyond that conventionally captured in payment card transactions.

In an embodiment, the system can be configured to integrate the gift mode interface with merchant servers or other systems. For example, at block 512 the system can be configured to share data about transactions made in gift mode with a merchant server system. At block 513, the system can then be configured to allow the merchant to make targeted offers to payment card users in gift mode, for example via the banking application while at a merchant's store, or via the SRC portal or payment card system interface when shopping online. In an embodiment, at block 514 the system can be configured to integrate a client side part 331 of a virtual assistant with a virtual assistant server 176 configured to assist the payment card user, for example with guided transactions, purchase and shopping assistance and planning, and promotional offers.

In an embodiment, at block 515, the system can be configured to integrate with merchant or payment card reward systems to offer additional rewards or use rewards in conjunction with the gift mode interface.

Exemplary system use cases are described below.

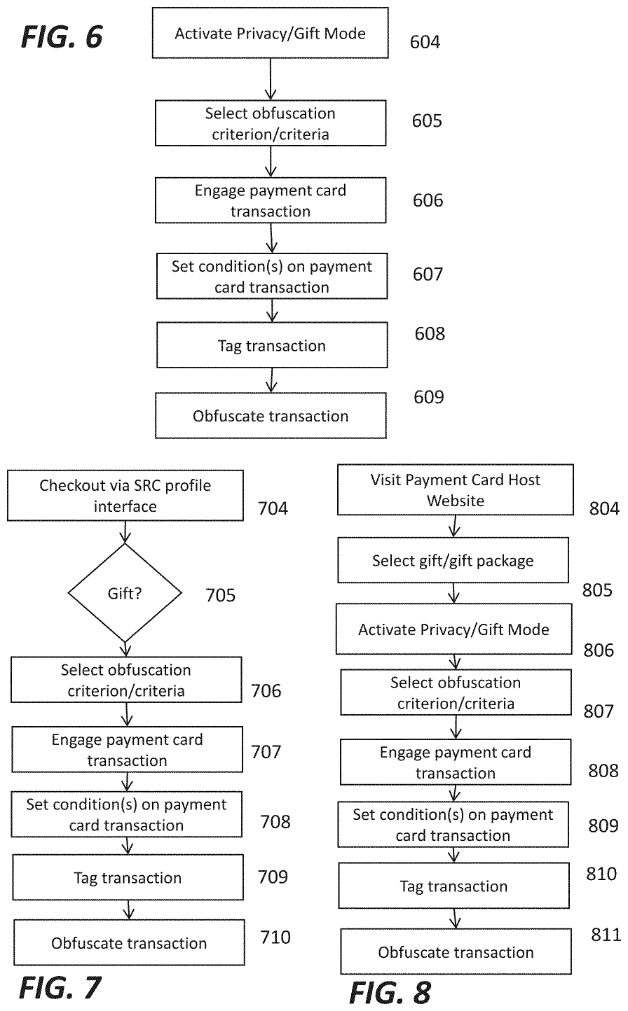

An exemplary system and use case process 600 is shown at FIG. 6. At block 604, in at least one of the various embodiments, a user engaging in a payment transaction at a merchant activates a privacy mode in a banking application 334. For example, a purchaser buying a gift of two tickets two months in advance of a show for a partner who shares the same payment card account (e.g. their spouse), and wants the show to be a surprise. To that end, prior to engaging in the transaction at a kiosk or ticket window, activates a “gift mode” on the banking application 334 on their user device—a smart phone.

At block 605, the user then sets an obfuscation criterion or criteria using the privacy mode. For example, the banking application 334 can be configured to allow the user to set a time for which any transactions using the account are tagged as obfuscated. In an embodiment, the banking application 334 can also be configured to allow a user to select a specific payment card for the transaction, such as a preferred card selected from a number of payment cards available to that user. Using the example above, the purchaser entering gift mode on the banking application 334 sets the gift mode for 30 minutes prior to buying the show tickets at a nearby ticket window. Any transactions made with the payment card for the next 30 minutes are obfuscated by the system.

Once the privacy mode is activated and the obfuscation criterion set, at block 606 the user engages in the transaction at the POS device. At block 607, the user can set a condition on the purchased good or service, for example, muting notifications or delaying delivery. For example, the purchaser buying the show tickets can select an option to deliver paper tickets to a work location and to mute all notifications of the transaction (e.g. texts, emails, third party financial management services).

At block 608, the control interface host 170 tags the transaction for that account as an obfuscated transaction. The control interface host then informs the payment card network or the card issuer 160 that transactions meeting the obfuscation criterion for the payment card account are obfuscated. At block 609, the issuer 160 then obfuscates the transaction on interfaces and reports as described herein. As such, the purchaser buying tickets can surprise their spouse, as notifications and interfaces have been hidden or obfuscated in the two months leading up to the show.

An exemplary system and use case process 700 is shown at FIG. 7. At block 704, in at least one of the various embodiments, a user engaging in an online payment transaction at a merchant website engages in a checkout via an SRC profile offered by the control interface host 170. For example, a purchaser buying a gift of two airline tickets from New York to Paris France for a surprise trip with another who shares the same payment card account (e.g. their spouse), and wants the trip to be a surprise.

At block 705 prior to engaging in the transaction checkout, the SRC profile initiates a privacy prompt, for example a pop-up that asks if the purchase is a gift. If the user selects yes, the SRC profile activates a “gift mode” for the online checkout transaction.

At block 706, the SRC profile can be configured to set an obfuscation criterion or criteria using the privacy mode. For example, the SRC profile can be configured to allow or prompt the user to set a time for which the transaction is obfuscated. In an embodiment, the obfuscation criterion or criteria can be a default. For example, the system can be configured to obfuscate the transaction unless the user removes or deselects the transaction as obfuscated.

Once the privacy mode is activated and the obfuscation criterion set, at block 707 the user engages in the transaction at the online checkout via their web browser 335 or application. At block 708, the user can set a condition on the purchased good or service, for example, muting notifications. For example, the purchaser buying the airline tickets can select an option to deliver paper tickets (as a present) to a work location and to mute all notifications of the transaction (e.g. texts, emails, third party financial management services).

At block 709, the control interface host 170 tags the transaction for that account as an obfuscated transaction. The control interface host then informs the payment card network or the card issuer 160 that transactions meeting the obfuscation criterion for the payment card account are obfuscated. At block 710, the issuer 160 then obfuscates the transaction on interfaces and reports as described herein. As such, the purchaser buying tickets can surprise their spouse, as notifications and interfaces have been hidden or obfuscated up to the time of flight.

An exemplary system and use case process 800 is shown at FIG. 8. At block 804, in at least one of the various embodiments, a user engaging in an online payment transaction visits a host website 320, for example a payment card company host, engages in a checkout via a rewards and purchase portal on offered by the payment card company host. For example, a purchaser buying a gift of an evening of dinner theater with another who shares the same payment card account (e.g. their spouse) and wants the night to be a surprise. The payment card holder accesses a special website 320, such as the “Priceless”™ online purchasing portal offered by MasterCard™.

At block 805, the user selects the dinner theater tickets and other related purchases, for example, car service and flower delivery.

At block 806, the website 320 is configured to allow the user to activate a “gift mode” on their web browser 335 or application accessing the website.

At block 807, the host website 320 can be configured to set an obfuscation criterion or criteria using the privacy mode. For example, the website 320 can be configured to allow or prompt the user to set a time for which the transaction is obfuscated. In an embodiment, the obfuscation criterion or criteria can be a default.

Once the privacy mode is activated and the obfuscation criterion set, at block 808 the user engages in the transaction at the online checkout via their web browser 335 or application. At block 809, the user can set a condition on the purchased good or service, for example, muting notifications. For example, the purchaser buying the dinner theater can select an option to deliver paper theatre tickets to a work location, have the flowers delivered and the car service arrive just before the time for going to the live show, and to mute all notifications of the transaction (e.g. texts, emails, third party financial management services).

At block 810, the control interface host 170 for the payment card company tags the transaction for that account as an obfuscated transaction. The control interface host 170 then informs the card issuer 160 that transactions meeting the obfuscation criterion for the payment card account are obfuscated. At block 811, the issuer 160 then obfuscates the transaction on interfaces and reports as described herein. As such, the purchaser of the dinner date can surprise their spouse with tickets, flowers, and the car service as notifications and interfaces have been hidden or obfuscated up to the time of the date.

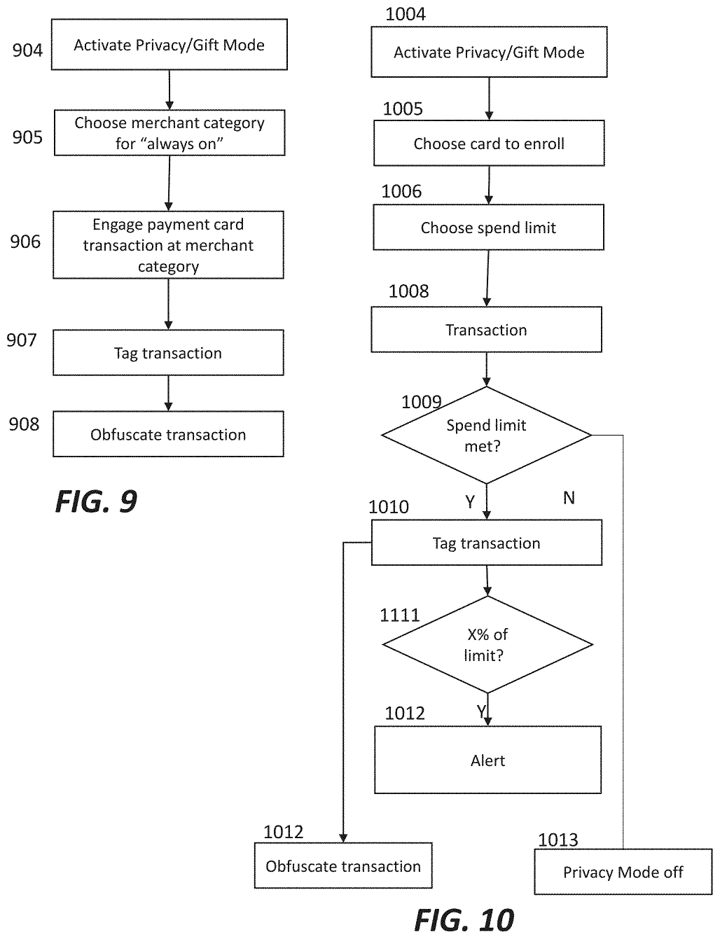

In at least one of the various embodiments, the system is configured to allow a user to set categories of purchase transactions for obfuscation. An exemplary system and use case process 900 is shown at FIG. 9. As block 904, a user activates a privacy mode in a banking application 334 or via an SRC profile.

At block 905, the user then sets an obfuscation criterion or criteria using the privacy mode. For example, the banking application 334 can be configured to allow the user to set product, service, or merchant type for which any transactions using the account are tagged as obfuscated. For example, the system can be configured to allow a user to select a one or more specific merchants or merchant categories for which transactions are always obfuscated. For example, a purchaser entering gift mode on the banking application selects “Tiffany's” “jewelry” as a product category. The system is then configured obfuscate all transactions any stores or purchases at Tiffany's or at any merchant falling into a jewelry category.

Once the privacy mode is activated and the obfuscation criterion set, at block 906 the user engages in a transaction meeting the merchant category at the POS device or online. At block 907 the control interface host 170 tags the transaction for that account as an obfuscated transaction. The control interface host then informs the payment card network or the card issuer 160 that transactions meeting the obfuscation criterion for the payment card account are obfuscated. At block 908, the issuer 160 then obfuscates the transaction on interfaces and reports as described herein. As such, the purchaser can buy jewelry as a surprise gift, as notifications and interfaces for jewelry purchases are always hidden or obfuscated.

An exemplary system and use case process 1000 is shown at FIG. 10. In an embodiment, the system can be configured to obfuscate transactions up to a spend limit. At block 1004, in at least one of the various embodiments, a user engaging in a payment transaction at a merchant activates a privacy mode in a banking application 334. At block 1005, the banking application 334 can also be configured to allow a user to select a specific payment card for the transaction, such as a preferred card selected from a number of payment cards available to that user. At block 1006, the user then sets a spend limit obfuscation criterion or criteria using the privacy mode. The banking application 334 or SRC portal can be configured to allow the user to set a spending limit up to which any transactions using the account while in the privacy mode are tagged as obfuscated. For example, the payment card user sets a spend limit of $200.00 for any transactions in the privacy mode.

After the spend limit criterion is set, at block 1008 the user enters privacy mode and engages in a transaction at a merchant POS device or online. At block 1009, the system determines if the amount of the transaction causes the privacy mode transactions to exceed the spend limit criterion. If so, at block 1013 the system is configured to turn the privacy mode off for transactions, and the transaction is not obfuscated.

For example, a family sets spend limit of $200.00 a month. Each of the family members on the account can activate the privacy mode for gifts or “no judgment” transactions, for example, movies, coffee or drinks, etc. Family member purchases on the account are at $196.00 before the end of the month when one family member decides to purchase a coffee drink costing $5.00. When the user enters gift mode, for example via the banking application 334, the application can be configured to display or inform the user that spending limit is almost reached, and the transaction can exceed the spend limit. When the user goes forward with the transaction, the transaction causes the account to exceed the $200.00 spend limit. The system is configured to deactivate the gift mode, and the transaction is not obfuscated.

If the spend limit criterion is not met, at block 1010, the control interface host 170 tags the transaction for that account as an obfuscated transaction. The control interface host then informs the payment card network or the card issuer 160 that transactions under the spend limit for the payment card account are obfuscated. At block 1111, the system can be configured to determine if the transaction has caused the gift mode transactions to reach a given percent of the spend limit (e.g.: 20%). If so, at block 1012 the system can be configured to send an alert to user, for example via SMS, email, the banking application, or on a given network portal (e.g.: Mint, the SRC portal, etc.). At block 1012, the issuer 160 then obfuscates the transaction on interfaces and reports as described herein.

Returning to the family spend limit of $200.00 a month, family member purchases on the account are at $156.00 before the end of the month when one family member decides to purchase a coffee drink costing $5.00. When the user goes forward with the transaction in gift mode, the transaction causes the account to come within 20% of the spend limit ($161.00). The application 300 can be configured to alert the user that privacy mode transactions are now within 20% spending limit. The system can also be configured to alert all the users on the family account that privacy mode transactions are now within 20% spending limit.

As described herein, in embodiments the system can be configured to send transaction data to a data analytics server of a data warehouse 200. In embodiments, information that is stored in one or more databases can be retrieved (e.g., by a processor), including information obtained during privacy or gift mode transactions. The information can contain, for example, a first set of information including internal information meaning information that can be retrieved from one or more databases owned or controlled by an entity, for example, a payment card company (part of the payment card company network 150 in FIG. 1A). Illustrative first set of information can include, for example, payment card transaction information, payment card holder information, merchant information, transaction date and time, and transaction amount. In particular, the payment card transaction information can include, for example, transaction date/time, transaction amount, payment card holder information (e.g., payment card holder account identifier (likely anonymized), payment card holder geography (potentially modeled), payment card holder type (consumer/business), payment card holder demographics, and the like), merchant information (e.g., merchant name, merchant geography, merchant line of business, and the like). Information for inclusion in the first set of information can be obtained, for example, from payment card companies known as MasterCard®, Visa®, American Express®, and the like (part of the payment card company network 150 in FIG. 1A).

Payment card transaction information can also include information for transactions tagged as obfuscated. In an embodiment, payment card transactions that are tagged as obfuscated can include, additional to the transaction information above, sentiment or mood information, gift or privacy motive information, and obfuscation criterion information (e.g., obfuscation category, type), and conditions applied to transactions. As described herein, transaction information can be anonymized for processing and analyses that are denuded of personally identifying cardholder information.

Also, the information can optionally contain, for example, a second set of information including external information, meaning information that is not owned by an entity and retrieved by an entity from a third party source. Illustrative second set information can include, for example, geographic data, firmographic data, demographic data, and the like. In particular, the second set of information can include, for example, geographic data, geographic areas (e.g., ZIP codes, metropolitan areas (metropolitan statistical area (MSA), designated market area (DMA), and the like), event venues, and the like), calendar information (e.g., retail calendar, seasonal/holiday information such as observances of shifting holidays such as Easter), weather (e.g., snowfall, rain, temperature, and the like), map data (e.g., highway exits, travel time, rest areas, nearest airport, and the like), and the like. The second set of information affords leveraged data sources that can supplement information in the first set of information.

The external information can further include firmographics data, for example, line of operations for a business, information related to employees, revenues and industries, and the like. In particular, the firmographics data relates to information on merchants that is typically used in credit decisions, business-to-business marketing and supply chain management.

Illustrative information in the firmographics data source includes, for example, information concerning merchant background, merchant history, merchant special events, merchant operation, merchant payments, merchant payment trends, merchant financial statement, merchant public filings, and the like merchant information.

Merchant background information can include, for example, ownership, history and principals of the merchant, and the operations and location of the merchant.

Merchant history information can include, for example, incorporation details, par value of shares and ownership information, background information on management, such as educational and career history and company principals, related companies including identification of affiliates including, but not limited to, parent, subsidiaries and/or branches worldwide. The merchant history information can also include corporate registration details to verify the existence of a registered organization, confirm legal information such as a merchant's organizational structure, date and state of incorporation, and research possible fraud by reviewing names of principals and business standing in a state.

Merchant special event information can include, for example, any developments that can impact a potential relationship with a company, such as bankruptcy filings, changes in ownership, acquisitions and other events. Other special event information can include announcements on the release of earnings reports. Special events can help explain unusual company trends, for example, a change in ownership could have an impact on manner of payment, or decreased production may reflect an unexpected interruption in factory operations (i.e., labor strike or fire).

Merchant operational information can include, for example, the identity of the parent company, the number of accounts and geographic scope of the business, typical selling terms, and whether the merchant owns or leases its facilities. The names and locations of branch operations and subsidiaries can also be identified.

Merchant public filing information can include, for example, bankruptcy filings, suits, liens, and judgment information obtained from Federal and State court houses for a company.

Demographic information can also be used to supplement or leverage the first set of information. Illustrative demographic information includes, for example, age, income, presence of children, education, and the like.

With regard to the sets of information, filters can be employed to select particular portions of the information. For example, time range filters can be used that can vary based on need or availability.

In an embodiment, all information stored in each of the one or more databases can be retrieved. In another embodiment, only a single entry in each database can be retrieved. The retrieval of information can be performed a single time, or can be performed multiple times. In an exemplary embodiment, only information pertaining to a specific predictive payment card holder sentiment or mood profile is retrieved from each of the databases.

Data analysis an include constructing data in a data layout that includes internal information and external information. The analyzing data portion includes constructing logical groupings of merchants, classifying data and/or aggregating data to support payment card holder purchase behavior determinations that can be made in part using purchase transaction information, and creating one or more algorithms for associating payment card holder purchase behaviors with groupings of merchants to identify, for example, payment card holder activities, sentiments, motives, or moods.

With regard to constructing logical groupings of merchants, merchants can be in the same line of business (e.g., jewelry stores, flower shops), merchants can have an association with a single activity (e.g., golfing, theatre), merchants can have an association with multiple activities (e.g., travel services), and merchants can be geographically associated with a certain activity (e.g., diner or gas station next to a theatre).

Merchant groupings can be determined in different ways, for example, by manual assignment or by automatic assignment. For manual assignment, an individual assigns merchants to a category based on research and/or known facts (e.g., line of business). For automatic assignment, data is self organized based on observations like payment card holder overlap. Standard statistical techniques can be employed, for example, clustering, regression, correlation, segmentation, raking, and the like.

The groupings of merchants can contain information including, for example, merchant identification, grouping identification, time period. The groupings of merchants can also contain information regarding factors such as quantification of how strong a merchant is tied to a merchant grouping (e.g., jewelry) merchant or flower merchant is a strong indicator of a romantic sentiment or mood, while shopping at a hobby merchant or a bookstore in is a weak indicator of a romantic interest, but correlates more strongly with a friendship sentiment.

As indicated herein, the merchant information can include categorization of merchants. The one or more databases are used for storing profiles of one or more merchants, and merchants belonging to a particular category, e.g., industry category. Illustrative merchant categories are described herein. The merchant categorization is useful for associating with payment card holder purchase behaviors to identify one or more payment card holder sentiments, moods, gifting, or privacy motives.

In an embodiment, a merchant category can include a segment of a particular industry. In some embodiments, the merchant category can be defined using merchant category codes according to predefined industries, which can be aligned using standard industrial classification codes, or using the industry categorization described herein.

Merchant categorization indicates the category or categories assigned to each merchant name. As described herein, merchant category information is used primarily for purposes of associating with payment card holder purchase behaviors and sentiments, moods, or motives to identify one or more payment card holder purchasing patterns, although other uses are possible. According to one embodiment, each merchant name is associated with only one merchant category. In alternate embodiments, however, merchants are associated with a plurality of categories as apply to their particular businesses. Generally, merchants are categorized according to conventional industry codes as defined by a selected external source (e.g., a merchant category code (MCC), Hoovers™, the North American Industry Classification System (NAICS), and the like). However, in one embodiment, merchant categories are assigned based on system operator preferences, or some other similar categorization process.

In accordance with this disclosure, merchant categorization is employed for associating with payment card holder purchase behaviors with one or more payment card holder sentiments, moods, gifting, or privacy motives. Proper merchant categorization can be employed to associate payment card holder sentiment, mood, gift, or privacy motive results that are truly reflective of the particular payment card holder sentiment and merchant association.

With regard to classifying data and/or aggregating data to support payment card holder purchase behavior determinations that can be made in part using purchase transaction information, indicators of travel and indicators of items purchases are used. Indicators of travel include, for example, gas, hotel, and dining transactions outside a payment card holder's area of residence.

Statistical techniques can be employed to, for example, cluster payment card holders together based on common purchasing characteristics (self organizing the data), and reviewing the logic used in making the association of individuals to each other. If the association seems to be based around a sentiment, mood, gift, or privacy motive, assign the sentiment, mood, gift, or privacy motive to the rule set used to build the clusters.

Several insights that can be applied result from the method of this disclosure. One insight is to create a data mart to store information specific to identifying payment card holder sentiments, moods, gifting, or privacy motives. The data mart can include existing data (e.g., payment card holder transaction data). The data mart can also include purpose built data (e.g., custom aggregations, custom merchant sets, external data, and the like). The data mart can further be a location to store output (e.g., predictive payment card holder sentiment, mood, gift, or privacy motive profiles).

Another insight is to create an infrastructure to execute programs that will run algorithms against raw data (e.g., internal data and external data) in order to generate assignments of payment card holder sentiment, mood, gift, or privacy motive. A further insight is to create a delivery mechanism for the data (e.g., standard file layout). Still another insight that can be applied is to create outputs (e.g., a data feed) that contains, at a minimum, payment card holder identification, sentiment, mood, gift, or privacy motive, and quantification of sentiment, mood, gifting, or privacy motive level. The output can be delivered to marketers or summarized in aggregate for advertisers. It can also be used for fraud analysis or to create behavior based on information products.

An exemplary dataset can store, review, and/or analyze of information used in the systems and methods of this disclosure. The dataset can contain a plurality of entries.

The internal information 202 includes payment card transactions and actual spending. More specifically, internal information 202 can include, for example, payment card transaction information, payment card holder information, merchant information, transaction date and time, transaction amount, payment card holder information (e.g., payment card holder account identifier (likely anonymized), payment card holder geography (potentially modeled), payment card holder type (consumer/business), payment card holder demographics, and the like), merchant information (e.g., merchant name, merchant geography, merchant line of business, and the like), payment transaction amount information, and the like. The external information 204 includes, for example, geographic data, firmographic data, demographic data, lists of individuals with interests and/or hobbies, and other suitable information that can be useful in conducting the systems and methods of this disclosure.

Algorithms can be employed to determine formulaic descriptions of the integration of the internal information and optionally the external information using any of a variety of known mathematical techniques. These formulas, in turn, can be used to derive or generate one or more analyses and updates using any of a variety of available trend analysis algorithms. For example, these formulas can be used to analyze the internal information and the external information to construct one or more groupings of merchants based on merchant line of business or merchant association with a sentiment, mood, gift, or privacy motive to construct the one or more payment card holder purchase behaviors, and/or construct one or more predictive payment card profiles.

The high level process flow also outputs a data feed that contains, at a minimum, payment card holder identification, sentiment, mood, gift, or privacy motive, and quantification of sentiment, mood, gift, or privacy motive level. The output can be delivered to marketers or summarized in aggregate for advertisers. The output can also be used for fraud analysis or to create behavior based on information products.

The several applications of this disclosure include, for example, making offers, preventing fraud, targeted advertisements, and the like.

One or more algorithms can be employed to associate payment card holder purchase behaviors with the groupings of merchants in order to identify payment card holder sentiment, mood, gift, or privacy motive, using any of a variety of known mathematical techniques. Standard statistical techniques (e.g., clustering, regression, correlation, segmentation, raking, and the like) can be used to develop an algorithm that will identify payment card holder sentiment, mood, gift, or privacy motive. The output of the algorithms can include formulas for identify payment card holder sentiment, mood, gift, or privacy motive, quantifying the strength of the payment card holder sentiment, mood, gift, or privacy motive, for example, a strong sentiment or a weak sentiment.

Associations between payment card holders and the groupings of merchants can be assessed based on the one or more predictive payment card holder privacy/gift profiles, for example, fraud assessment situation or a targeted advertisement.

The above examples illustrate how the systems and the methods of this disclosure can be used to make associations between payment card holders and groupings of merchants based on the one or more predictive payment card holder privacy/gift profiles. In particular, the systems and the methods of this disclosure can be used by merchants or businesses to better target customers or to enhance existing customer relationships, and also be used to prevent or reduce the risk of fraud in payment card transactions.

As indicated herein, the systems and the methods of this disclosure utilize standard statistical techniques (e.g., clustering, regression, correlation, segmentation, raking, and the like) to associate the payment card holder purchase behaviors with the groupings of merchants to identify payment card holder sentiment, mood, gift, or privacy motive, and applying the logic to a universe of payment card holders to identify payment card holder hobbies or interests of the universe of payment card holders. The associations and relationships can be refined by looking at factors such as time, logical geographic breaks, frequency, and the like.

Logic can be created for associating the payment card holder purchase behaviors with the groupings of merchants to identify one or more payment card holder sentiment, mood, gift, or privacy motive, and then quantifying their association or relationship (e.g., confidence quantifier). Once the logic has been created, it can be applied to a universe of payment card holders to identify one or more payment card holder's sentiment, mood, gift, or privacy motive of the universe of payment card holders. Attributes (e.g., confidence, time, frequency, and the like) can then be assigned to clusters and/or members of the clusters to make the data useful to potential end users such as marketers and fraud investigators.

A confidence score can be used for conveying to the one or more entities suggested gifts or purchases for one or more payment card holders based on the one or more predictive payment card holder privacy/gift profile. The confidence score is indicative of likelihood of a payment card holder to have a certain sentiment, mood, gift, or privacy motive.

Predictive payment card holder privacy/gift profiles are generated from the information obtained from the one or more databases. The information is analyzed, extracted and correlated by, for example, a financial transaction processing company (e.g., a payment card company), and can include financial account information, merchant information, external information, performing statistical analysis on financial account information, the merchant information and the external information, finding correlations between account information, merchant information, external information and payment card holder behaviors, predicting future payment card holder behaviors based on account information, merchant information and external information, relating information on a financial account, a merchant and external information with other financial accounts, merchants and external information, or any other method of review suitable for the particular application of the data, which will be apparent to persons having skill in the relevant art.

Activities and characteristics (e.g., sentiment, mood, gift, or privacy motive) attributable to the payment card holders based on the one or more predictive payment card holder privacy/gift profiles are identified. The payment card holders have a propensity to carry out certain activities and to exhibit certain characteristics (e.g., sentiment, mood, gift, or privacy motive) based on the one or more predictive payment card holder privacy/gift profiles. The activities and characteristics attributable to the payment card holders and based on the one or more predictive payment card holder privacy/gift profiles are conveyed, for example, by a financial transaction processing entity to an entity making the targeted offer or to an entity involved with preventing fraud. This conveyance enables a targeted offer to be made by the entity to the payment card holders or enables fraud prevention by the entity. The transmittal can be performed by any suitable method as will be apparent to persons having skill in the relevant art.

In an embodiment, the information retrieved from each database can be analyzed to determine behavioral information of the payment card holders. Also, information related to an intent of the payment card holders can be extracted from the behavioral information. The predictive payment card holder privacy/gift profiles can be based upon the behavioral information of the payment card holders and the intent of the payment card holders. The predictive payment card holder privacy/gift profiles can be capable of predicting behavior and intent in the payment card holders (e.g., sentiment, mood, gift, or privacy motive).

Predictive payment card holder privacy/gift profiles can be updated or refreshed at a specified time (e.g., on a regular basis or upon request of a party). Updating predictive payment card holder privacy/gift profiles can include updating the entities included in each predictive payment card holder privacy/gift profile with updated demographic data and/or updated financial data and/or updated merchant data. Predictive payment card holder privacy/gift profiles can also be updated by changing the attributes that define each predictive payment card holder privacy/gift profile, and generating a different set of behaviors. The process for updating behavioral information can depend on the circumstances regarding the need for the information itself.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system or even a group of multiple computer systems. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions. The foregoing example should not be construed as limiting and/or exhaustive, but rather, an illustrative use case to show an implementation of at least one of the various embodiments of the invention.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it can be based on one or more other things as well. In other words, unless expressly indicated otherwise, as used herein “based on” means “based at least in part on” or “based at least partially on.”

The techniques described herein are exemplary, and should not be construed as implying any particular limitation on the present disclosure. It should be understood that various alternatives, combinations and modifications could be devised by those skilled in the art from the present disclosure. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A system comprising:
a host server comprising a control interface and an obfuscation server;
a payment card processing system comprising a processor for processing a payment card transaction;
a client device comprising a payment card user module, the payment card user module comprising an obfuscation client configured to include an obfuscation transaction mode interface;
a financial server comprising a reporting module configured to obfuscate transactions on a payment card reporting interface;
the control interface being configured to allow the payment card user to, via the client device,
select a payment card for use with the obfuscation transaction mode interface; and
select or implement an obfuscation criterion for a payment card transaction using the selected payment card; and
the obfuscation server is configured to categorize a payment card transaction meeting the obfuscation criterion as an obfuscated payment card transaction.

2. The system of claim 1 wherein the client device is configured to allow a user to activate an obfuscation mode with obfuscation transaction mode interface.

3. The system of claim 1 wherein the client device comprises a banking application including the payment card user module.

4. The system of claim 1 wherein the obfuscation server comprises a web server configured to serve a commerce profile interface to the client device.

5. The system of claim 4, wherein the commerce profile interface is configured to prompt the payment card user via the client device to identify if a payment card transaction is an obfuscated transaction.

6. The system of claim 2, wherein the obfuscated transaction mode interface is configured to allow a user to set one or more conditions on the transaction.

7. The system of claim 2, wherein the obfuscated transaction mode interface is configured to allow the user to set privacy controls on the transaction.

8. The system of claim 4, wherein the commerce profile interface is served as a dedicated website or secure remote commerce profile.

9. The system of claim 4, wherein the system is configured to allow a user to designate a class of transactions as the obscured transaction criterion.

10. The system of claim 4, wherein the commerce profile interface is configured to allow a user to set the obscured transaction criterion as a transaction amount above which the transaction will be obfuscated.

11. The system of claim 4 wherein the commerce profile interface is configured to allow a user to set the criterion as a transaction amount for which any transactions under that amount that can be obfuscated.

12. The system of claim 10 wherein the system is configured to alert a user when one or more transactions come within a percent or amount of the transaction amount.

13. The system of claim 10, wherein the amount can be set as an aggregate amount for a plurality of cardholders associated with a single payment card account.

14. The system of claim 13 wherein the system is configured to maintain separate limits for each cardholder until the aggregate amount for the single payment card account is met.

15. The system of claim 2 wherein the system is configured to allow the obfuscation transaction mode to be active for designated period of time.

16. The system of claim 1 wherein the system is configured to block or prevent permissioned third party systems from accessing obfuscated transactions.

17. The system of claim 2 wherein the system is configured to obfuscate obfuscated transactions on interfaces configured to report or display transactions.

18. The system of claim 17, wherein the system is configured to obfuscate obfuscated transactions by one or more of:
re-organizing a statement to display obfuscated transactions on a separate page or area;
hide transactions in an object requiring activation of the object to display the obfuscated transaction.

19. A method of obfuscating transactions, the method being performed by a computer system that comprises one or more processors, a memory operatively coupled to at least one of the processors, and a computer-readable storage medium encoded with instructions executable by at least one of the processors, the method comprising:
providing a client device with a payment card user module, the payment card user module comprising an obfuscation client configured to include an obfuscation transaction mode interface to a host server comprising a control interface and an obfuscation server; the control interface being configured to allow the payment card user to, via the client device,
select a payment card for use with the obfuscation transaction mode interface; and
select or implement an obfuscation criterion for a payment card transaction using the selected payment card;
the obfuscation server being configured to categorize a payment card transaction meeting the obfuscation criterion as an obfuscated payment card transaction;
providing a financial server with a reporting module configured to obfuscate transactions on a payment card reporting interface;
process a payment card transaction with a payment card processing system; and
if the payment card transaction meets the obfuscation criterion, obfuscate the payment card transaction on the payment card reporting interface.

20. The method of claim 19 comprising: providing the client device with the obfuscation transaction mode interface configured to allow a user to activate an obfuscation mode

21. The method of claim 20, wherein the obfuscated transaction mode interface is further configured to allow a user to set one or more conditions on the transaction, or set privacy controls on the transaction, or both.

22. A computer program product comprising a computer-readable storage medium encoded with instructions that, when executed by at least one processor within a computer system that comprises one or more processors and a memory operatively coupled to at least one of the processors, cause the computer system at least to:
provide a client device with a payment card user module, the payment card user module comprising an obfuscation client configured to include an obfuscation transaction mode interface to a host server comprising a control interface and an obfuscation server;
provide a financial server with a reporting module configured to obfuscate transactions on a payment card reporting interface;
allow the payment card user to, via the client device,
select a payment card for use with the obfuscation transaction mode interface; and
select or implement an obfuscation criterion for a payment card transaction using the selected payment card, the obfuscation server being configured to categorize a payment card transaction meeting the obfuscation criterion as an obfuscated payment card transaction;
process a payment card transaction with a payment card processing system; and
if the payment card transaction meets the obfuscation criterion, obfuscate the payment card transaction on the payment card reporting interface.
